(19) United States
(12) Patent Application Publication
(10) Pub. No.: US 2005/0253872 A1
(43) Pub. Date: Nov. 17, 2005

(54) Method and system for culling view dependent visual data streams for a virtual environment

(76) Inventors: Michael E. Goss, Burlingame, CA (US); Daniel G. Gelb, Redwood City, CA (US); Thomas Malzbender, Palo Alto, CA (US)

Correspondence Address: HEWLETT-PACKARD COMPANY;Intellectual Property Administration, P.O. Box 272400, Fort Collins, CO, 80527-2400, US

(21) Appl. No.: 10/684,030

(22) Filed: Oct. 9, 2003

(51) Int. Cl. G09G 5/00; G06F 15/16

(52) U.S. Cl. 345/660; 709/231

(57) ABSTRACT

A method for culling visual data streams. Specifically, one embodiment of the present invention discloses a method for culling view dependent visual data streams for a virtual environment. The method begins by determining a view volume of a viewing participant within the virtual environment. The view volume determines a field-of-view of the viewing participant within the virtual environment. The embodiment of the method then determines a proximity of a representation of an observed object in the virtual environment to the view volume. Thereafter, the embodiment of the method processes a view dependent visual data stream of the observed object only when the representation is within a specified proximity to the view volume.

### RELATED UNITED STATES PATENT APPLICATION

This Application is related to U.S. patent application Ser. No. 10/176,494 by Thomas Malzbender et al., filed on Jun. 21, 2002, entitled “Method and System for Real-Time Video Communication Within a Virtual Environment” with attorney docket no. 100203292-1, and assigned to the assignee of the present invention.

### TECHNICAL FIELD

The present invention relates to the field of visual data, and more particularly to a method for culling visual data for a shared virtual environment.

### BACKGROUND ART

A communication network to support a virtual environment supported by N participants can be quite complex. In a virtual environment supported by N participants, there are N nodes within the communication network. For a full richness of communication, each node that represents a participant may generate a different data stream to send to each of the other nodes. There is a computational cost associated with producing each data stream. In addition, there is a communication cost associated with transmitting data streams between the nodes.

As the number N of participants grows, computational and communication bandwidth complexities increase in order to support the increasing number of participants. As such, maintaining scalability of the communication network as the number N increases becomes more important. For example, in the case where a different data stream is sent to each of the other participants, the local computer must generate and transmit N−1 data streams, one for each of the other participants. At the local level, computational complexity scales with the number of participants. As such, as the number N of participants increases, the computational capacity of the local computer may be exceeded depending on the processing power capabilities of the local computer. As such, the amount of computation will become prohibitive as N grows.

At the network level, when each of the N participants are generating a separate data stream for each of the other participants, this leads to a total of N(N−1) data streams that are transmitted over the entire communication network. Both at the local and network levels, the amount of communication transmitted over the network may exceed the network's capabilities as N grows. As such, the amount of communication will become prohibitive as N grows.

What is needed is a reduction in both computational complexity and communication traffic under certain conditions. As such, immersive communication systems will be able to scale to larger values of N.

### DISCLOSURE OF THE INVENTION

A method for culling visual data streams. Specifically, one embodiment of the present invention discloses a method for culling view dependent visual data streams for a virtual environment. The method begins by determining a view volume of a viewing participant within the virtual environment. The view volume determines a field-of-view of the viewing participant within the virtual environment. The embodiment of the method then determines a proximity of a representation of an observed object in the virtual environment to the view volume. Thereafter, the embodiment of the method processes a view dependent visual data stream of the observed object only when the representation is within a specified proximity to the view volume.

### BRIEF DESCRIPTION OF THE DRAWINGS

FIG. 1A is a diagram of an exemplary communication network for facilitating communication within an N-way collaborative environment, in accordance with one embodiment of the present invention.

FIG. 1B is a physical representation of communication paths within the communication network of FIG. 1A, in accordance with one embodiment of the present invention.

FIG. 2 is a flow diagram illustrating steps in a computer implemented method for culling view dependent visual data for a virtual environment, in accordance with one embodiment of the present invention.

FIG. 3 is a diagram illustrating a view volume of a viewing participant within a virtual environment, in accordance with one embodiment of the present invention.

FIG. 4 is a diagram illustrating occlusion of an object within a virtual environment, in accordance with one embodiment of the present invention.

FIG. 5 is a diagram illustrating an extended bounding volume used for hysteresis and anticipation, in accordance with one embodiment of the present invention.

FIG. 6 is a system that is capable of rendering an image in an N-way collaborative environment, in accordance with one embodiment of the present invention.

### BEST MODES FOR CARRYING OUT THE INVENTION

Reference will now be made in detail to the preferred embodiments of the present invention, a method and system of culling view dependent visual data streams for a virtual environment. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Embodiments of the present invention can be implemented on software running on a computer system. The computer system can be a personal computer, notebook computer, server computer, mainframe, networked computer, handheld computer, personal digital assistant, workstation, and the like. This software program is operable for culling visual data streams for a virtual environment. In one embodiment, the computer system includes a processor coupled to a bus and memory storage coupled to the bus. The memory storage can be volatile or non-volatile and can include removable storage media. The computer can also include a display, provision for data input and output, etc.

Accordingly, the present invention provides a method and system for culling visual data streams (e.g., video, images, graphics primitives, etc.) for a virtual environment (e.g., an N-way collaborative environment). As a result, embodiments of the present invention are capable of reducing both computational complexity and communication traffic in an N-way collaborative environment. As such, immersive communication systems will be able to scale to larger values of N.

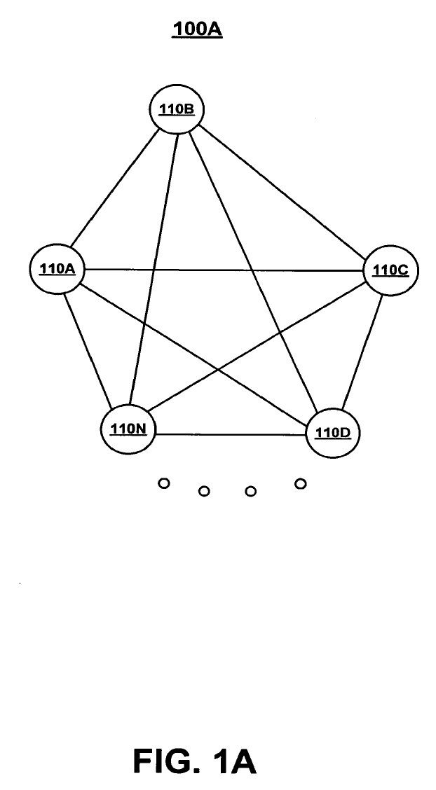

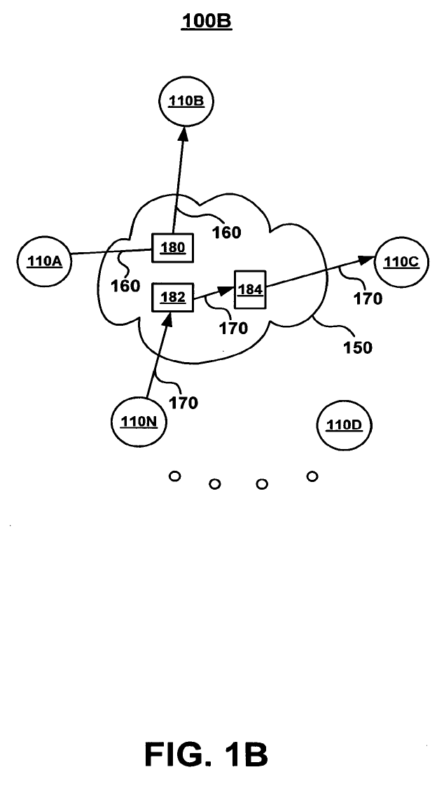

FIG. 1A is a diagram of a virtual representation of communication paths within a communication network 100A that is capable of supporting an N-way collaborative virtual environment, in accordance with one embodiment of the present invention. For purposes of clarity, the actual routing topology through routers and switches through the communication network 100A is not shown. Embodiments of the present invention are well suited to application within a class of communication systems that allow multiple numbers of users or participants to interact in a collaborative virtual environment, the N-way collaborative virtual environment.

The communication network 100A comprises N nodes, as follows: node 110A, node 100B, node 110C, node 110D, on up to node 110N. In FIG. 1A, at least two communication paths are set up between one sending participant and two receiving participants, as an example, to achieve the benefits derived from culling visual data streams. A participant is associated with each of the nodes in the communication network 100. Each of the participants at each node interacts with the remaining participants through the representation of the communication network 100A in order to participate within the N-way collaborative virtual environment. For example, the participant at node 110A communicates with the remaining participants (participants at nodes 110B-N) through the communication network 100A.

The nodes within the communication network 100A can produce data streams for some or all of the other nodes within the communication network 100A. In one embodiment, the data streams are view dependent. That is, data streams of an object are generated based on a viewpoint of a receiving participant. As such, the data stream that is generated of the observed object is dependent upon the view point of the receiving participant.

FIG. 1B is a diagram illustrating the physical representation of a communication network 100B that supports an N-way collaborative environment, in accordance with one embodiment of the present invention. FIGS. 1A and 1B illustrate the transparent nature of the underlying network 150 that supports the N-way collaborative virtual environment. As shown in FIG. 1B, the participants 110A-N communicate through a network 150 (e.g., the Internet). Within the network 150, communication traffic is transmitted through various devices 180, 182, and 184, such as, routers and/or switches. For illustrative purposes only, participant 110A sends a data stream to participant 110B through device 180 over communication path 160. Also, participant 110N sends a data stream to participant 110 through devices 182 and 184 over communication path 170. In that way, each of the participants can communicate with the other participants through the underlying network 150.

With increasing N, the computational cost associated with producing each distinct stream increases. In addition, the communication cost for transmitting the data streams to each of the nodes within the communication network 100 increases. Embodiments of the present invention are capable of reducing the overall computational costs as well as the volume and cost of communication traffic through the network allowing the communication network 100 to scale to larger values of N.

While embodiments of the present invention are disclosed for culling visual data streams for use in an N-way collaborative environment (e.g., video conferencing), other embodiments are well suited to culling visual data in any virtual environment.

As previously stated, in one embodiment, the N-way collaborative environment comprises a three-dimensional virtual environment. That is, images in real-time of an observed object (e.g., a sending participant) are generated from the viewpoints of a viewing participant (e.g., a receiving participant) within the virtual N-way collaborative environment.

In one embodiment, the images are generated by new view synthesis techniques based on sample video streams of the observed object. Construction of each of the (N−1) new views of an observed object is done with various new view synthesis techniques. The new view synthesis techniques construct, from the various real-time video streams of the observed object taken from the multiple sample perspectives, a new view taken from a new and arbitrary perspective, such as, the perspective of a viewing participant in the virtual environment.

An intermediate step includes rendering a three dimensional model of the observed object, from which the new view of the observed object is generated. The three-dimensional model is generated from the various real-time video streams of the observed object. For example, the 3D model is constructed from synchronous video frames taken from multiple sample camera perspectives. The 3D model forms the basis for creating avatars representing the observed object in the N-way collaborative environment. Renderings of an observed object's avatar from the perspective of other viewing participants are generated. As a result, the images of the avatars are sent to the viewing participants. The activity between the nodes participating in the N-way collaborative environment is highly interactive.

In other embodiments, an image based visual hull (IBVH) technique is used to render the three dimensional model of the observed object from the perspective of a viewing participant. For example, the IBVH technique back projects the contour silhouettes into a three-dimensional space and computes the intersection of the resulting frusta. The intersection, the visual hull, approximates the geometry of the user. Rendering this geometry with view-dependent texture mapping creates convincing new views.

In other embodiments, other reconstruction techniques instead of IBVH and image-based polygonal reconstruction techniques are used to render a three dimensional model of the sending participant from the perspective of an observing participant.

Processing can be accomplished at the local computer associated with the sending participant or any suitable intermediate location within the network. As a result, the rendered images and opacity maps are transmitted to all participants. That is, the outputs are combined with three dimensional computer generated synthetic renderings of the background to provide for photo-realistic versions of the sending participant within the virtual environment. The virtual environment also includes photo-realistic versions of other participants. The N-way collaborative environment is viewed by all participants from the perspectives of their corresponding avatars within the virtual environment.

While embodiments of the present invention are described within the context of an N-way collaborative environment (e.g., an N-way video conference), other embodiments are well suited to other environments (e.g., video gaming) that provide for interaction between multiple participants within the virtual environment.

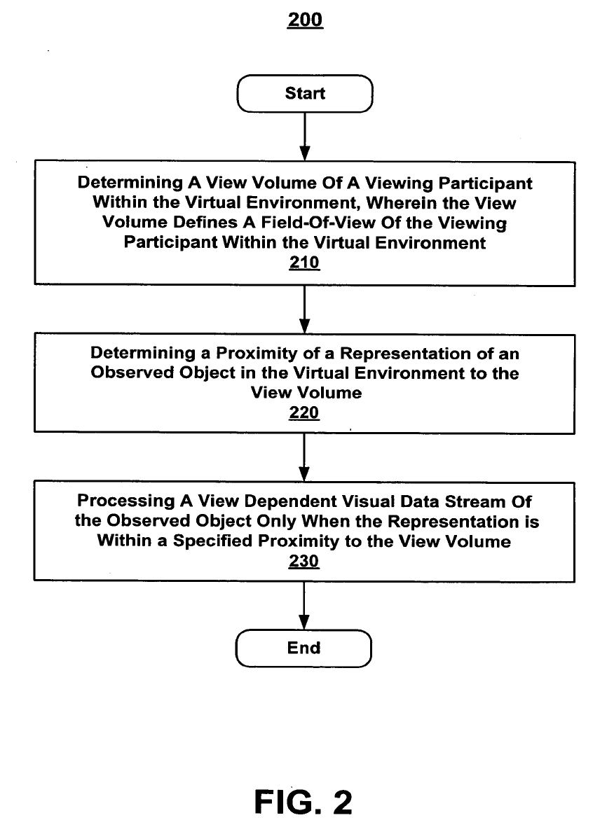

FIG. 2 is a flow chart 200 illustrating steps in a computer implemented method for culling visual data streams for a virtual environment, in accordance with one embodiment of the present invention. In the virtual environment, each participant can possibly transmit one or more visual data streams continuously to some or all of the other participants. More specifically, the present embodiment is capable of culling view dependent visual data streams of an observed object so that is only necessary to transmit visual data streams to those viewing participants for which the observed object is visible.

The present embodiment begins by determining a view volume of a viewing participant within a virtual environment, at 210. The view volume defines a field-of-view of the viewing participant within the virtual environment. To define the view volume, the present embodiment determines a view direction of the view volume associated with the viewing participant. The view direction defines the center line along which the viewing participant is viewing the virtual environment.

The present embodiment then continues by determining a proximity of a representation of an observed object in the virtual environment to the view volume, at 220. That is, the present embodiment is determining how close is the observed object to the view volume of the viewing participant.

At 230, the present embodiment then processes a view dependent visual data stream of the observed object only when the representation is within a specified proximity to the view volume. The term “processing” includes such actions, such as, transmitting, generating, reading from storage, etc.

Thereafter, the view dependent visual data stream of the observed object is sent to the viewing participant. As such, computational efficiency is realized at a local node since only view dependent visual data streams of the observed object are generated when the observed object is potentially viewable. This ensures that view dependent visual data streams of the observed object are not generated for a viewing participant, when the observed object is definitely not within the view volume of a viewing participant.

In one embodiment, a video image stream of the local object is generated from a three-dimensional model only when the representation is within a specified proximity to the view volume. That is, when the local object is within the specified proximity to the view volume within the virtual environment, then a video image stream of the local object is generated from the perspective of the viewing participant the video image stream is then sent to the viewing participant.

As described previously, a new view synthesis technique is used to generate the output video image stream. The new view synthesis technique is applied to the 3D model of the local object to generate the video image stream of the local object from the perspective of the viewing participant. The video image stream that is sent to the viewing participant is blended within a synthetic rendering of the three-dimensional virtual environment. As such, the local object is rendered from the perspective or viewpoint of the viewing participant within the virtual environment as viewed by the viewing participant.

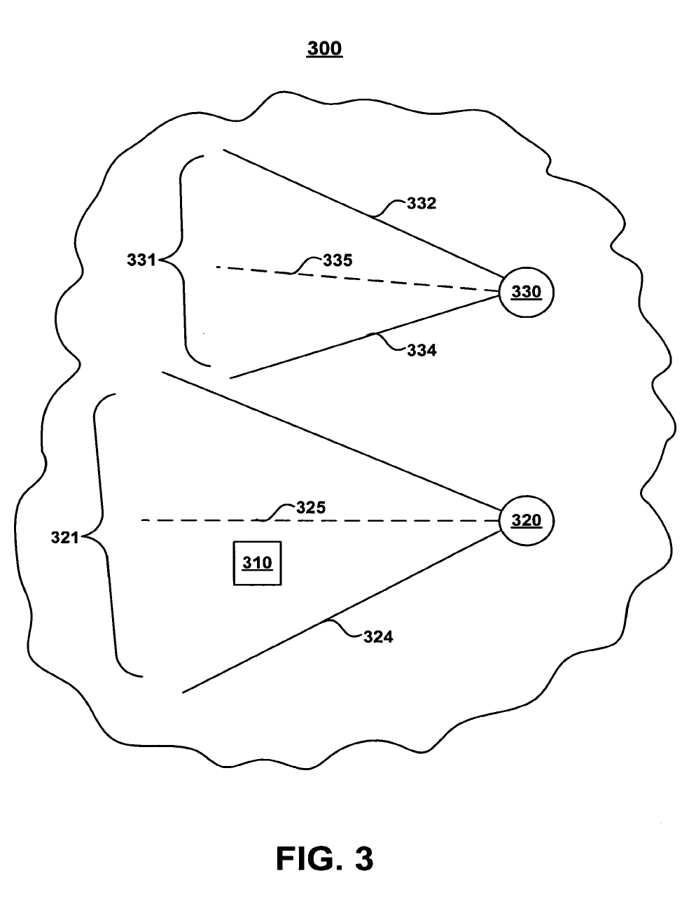

Now referring to FIG. 3, a 3D virtual environment 300 is shown. The 3D virtual environment 300 comprises an N-way collaborative environment in which an N-way immersive communication session is supported. In FIG. 3, a portion of the 3D virtual environment 300 is shown to illustrate view volumes of viewing participants. Three participants are shown in the 3D virtual environment 300 of FIG. 3, as follows: a local participant 310 (e.g., an observed object), and two viewing participants 320 and 330.

FIG. 3 illustrates the view volumes of the viewing participants 320 and 330 within the virtual environment 300. A view volume is defined as the region of virtual space within the virtual environment 300 where virtual objects (including the avatars of other participants) within the virtual environment 300 are potentially visible to a viewing participant.

For example, a top-down view of the view volume 321 for viewing participant 320 is defined by dotted lines 322 and 324 within the virtual environment 300. The view volume 321 defines a field-of-view for the viewing participant 320. The view volume 321 is centered around the view direction along line 325. As shown in FIG. 3, the local participant 310 is located within the view volume 321 of the viewing participant 520.

Also, a top-down view of the view volume 331 for viewing participant 330 is defined by dotted lines 332 and 334 within the virtual environment 300. The view volume 331 defines a field-of-view for the viewing participant 330. The view volume 331 is centered around the view direction along line 335. As shown in FIG. 3, the local participant 310 is outside of the view volume 331 of the viewing participant 330.

In one embodiment, the view volume comprises a series of expanding cross-sections of a geometric object along the previously defined view direction. The series of expanding cross sections originate from a point that is defined by a location of the viewing participant within the virtual environment.

In one embodiment, the geometric object comprises a four sided rectangular plane. As such, within the virtual environment, the view volume comprises a four-sided pyramid. The viewing participant is looking into the four-sided pyramid from the tip of the pyramid. As such, objects of the virtual environment located within the four-sided pyramid are potentially viewable to the viewing participant.

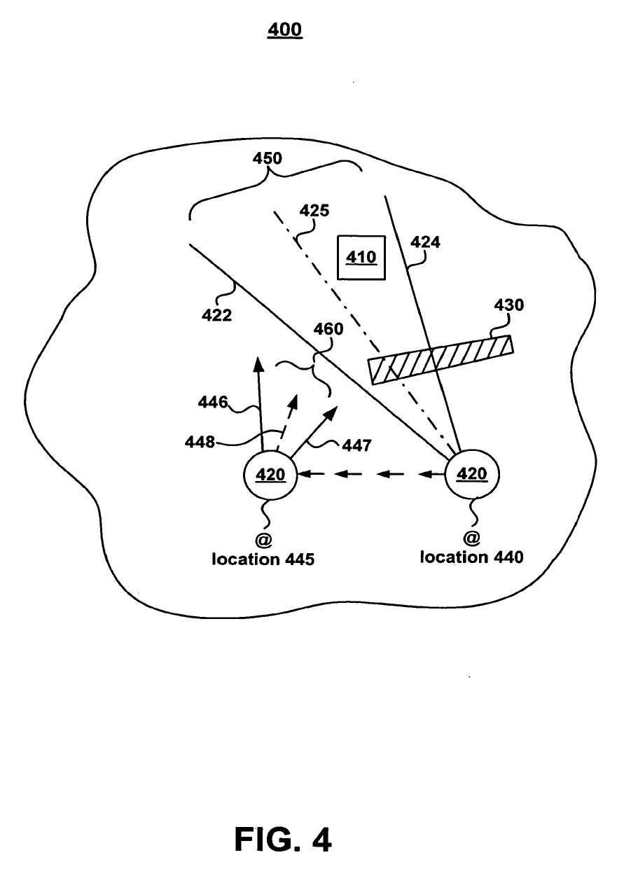

FIG. 4 is a diagram of a 3D virtual environment 400 that supports an interactive N-way collaborative session. In FIG. 4, a portion of the 3D virtual environment 400 is shown to illustrate occlusion within the view volume of a viewing participant 420, in accordance with one embodiment of the present invention. Two participants are shown in the 3D virtual environment 400 of FIG. 4, as follows: a local participant 410, and a viewing participant 420.

In the present embodiment, the view volume of the viewing participant 420 takes into account occlusion. That is, the viewing participant 420 can only view the local participant 410, representing an observed object, when the local participant 410 is visible to the viewing participant 420 within the virtual environment 400. More specifically, although the local participant 410 is within a view volume 450 centered around a viewing direction 425, the local participant 410 may still not be visible to the viewing participant 420 due to occlusion from the object 430. That is, visibility of the local participant 410 is achieved when the local participant 420 is within the specified proximity of the view volume of the viewing participant 420, and the local participant 410 is not completely occluded from the viewing participant 420 within the virtual environment 400.

For example, in FIG. 4, the viewing participant 420 has a view volume 450 defined by lines 422 and 424 and centered around the viewing direction 425. The viewing participant 420 is located at location 440 within the virtual environment 400. While the local participant 410 is well within the view volume 450 of the viewing participant 420, the local participant 410 is occluded by an object 430, such as, a wall. As such, the local participant 410 is not visible to the viewing participant 420 within the virtual environment 400.

As a result, in another embodiment, a method for generating image renderings for a view dependent virtual environment accounts for occlusion. The embodiment begins by determining that the representation of the observed object (e.g., local participant) is within a specified proximity to the viewing volume of the viewing participant. Then, the present embodiment is capable of determining when the representation is occluded in the view volume such that the observed object is not visible to the viewing participant. As a result, the present embodiment does not generate a visual data stream of the observed object when the representation is occluded. In this way, the computational expense when generating the unnecessary video image stream of an occluded object (the local participant) is avoided.

In another embodiment, the visibility of the local participant may change due to any or all of the following actions: the viewing participant may change a view direction of his or her field-of-view; the viewing participant may move within the virtual environment; the motion of other participants, or objects within the virtual environment; and the creation or deletion of objects in the virtual environment.

In FIG. 4, the movement of the viewing participant 420 illustrates that the visibility of the local participant 410 varies as a function of time and activity within the virtual environment 400. In FIG. 4, the viewing participant 420 moves from location 440 to location 445. When the viewing participant was located at location 440, the local participant 410 was not visible to the viewing participant 420 due to occlusion from the object 430.

However, when the viewing participant 420 moves to location 445, the view volume 460 as defined by lines 446 and 447, and centered along viewing direction 448, for the viewing participant 420 includes the local participant 410. As a result, the local participant 410 now is visible to the viewing participant 420. In this case, the video image stream of the local participant 410 can then be generated and sent to the viewing participant 420.

As a result, a method for image rendering is capable of enabling a change in a location of a viewing participant within a three-dimensional virtual environment, in accordance with one embodiment of the present invention. The present embodiment determines another view volume, a new view volume, of the viewing participant within the virtual environment. The new view volume is defined by the viewpoint of the viewing participant after moving to the new location within the virtual environment. The representation of the viewing participant within the virtual environment reflects the movement of the viewing participant.

The present embodiment determines when the representation falls within this new view volume. As such, the present embodiment generates a video image stream of the local participant from the three-dimensional model when the representation is within the specified proximity to the another view volume. That is, the local participant is visible to the viewing participant in the new view volume associated with the movement of the viewing participant to the new location.

In another embodiment, hysteresis and anticipation is provided for when delivering the video image stream to the viewing participant. Starting or restarting a network media stream in response to visibility change is not an instantaneous process.

To prevent a delay in the appearance of an associated video stream when an object becomes available, some additional processing is required. As a result, “anticipation” refers to the ability to determine in advance if an inactive or non-existent media stream is likely to be needed in the very near future. “Hysteresis” refers to the maintenance of a media stream even though is no longer associated with the visible participant or object, when there is a likelihood that the media stream may again be required in the near future.

When the representation of the observed object is within a specified proximity to the view volume the video image stream is generated. This allows for representations of the local participant to be generated even though the representation may not be actually within the view volume of the viewing participant. This is helpful to achieve visibility anticipation and hysteresis. The present embodiment, promotes anticipation and hysteresis by defining an extended bounding volume that surrounds the observed object within the virtual environment. As such, the aforementioned representation of the observed object within the virtual environment comprises the extended bounding volume when determining proximity to a view volume of a viewing participant.

In general, a minimum bounding volume comprises a simplistic 3D geometric object, such as, a sphere or cube, that completely contains the observed object. Usually, the minimum bounding volume comprises the smallest 3D object that will contain the observed object. Correspondingly, the extended bounding volume comprises an extra region of 3D space around the minimum bounding volume. As such, the extended bounding volume comprises the representation of the observed object within the virtual environment.

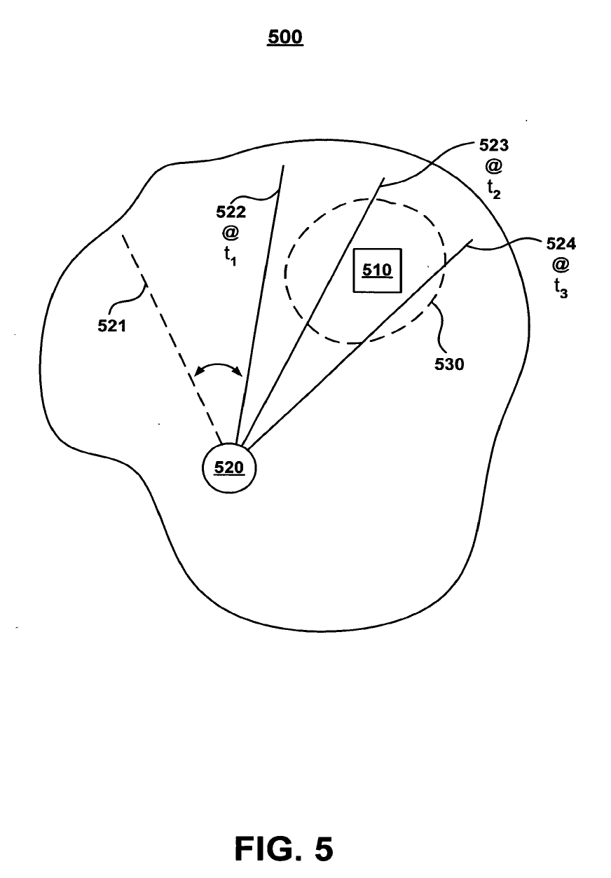

FIG. 5 is a diagram of a 3D virtual environment 500 that supports a virtual environment (e.g., an interactive N-way collaborative environment). In FIG. 5, a portion of the 3D virtual environment 500 is shown to illustrate the concept of anticipation and the promotion of hysteresis within a view volume of a viewing participant 520, in accordance with one embodiment of the present invention. Two participants are shown in the 3D virtual environment 500 of FIG. 5, as follows: a local participant 510 (representing an observed object), and a viewing participant 520.

In FIG. 5, the local participant 510 does not move within the virtual environment 500 for purposes of illustration. In addition, the viewing participant 520 does not change location within the virtual environment 500. However, the view volume, or field-of-view of the viewing participant 520 is changing within the virtual environment 500. That is, the field-of-view for the viewing participant 520 is rotating clockwise. For example the view volume of the viewing participant 520 is defined by the dotted line 521 and the solid line 522 at an initial position at time t-1. At the initial position, the local participant 510 is outside of the view volume of the viewing participant 520.

Solid line 522 represents the leading edge of the view volume associated with viewing participant 520 as the field-of-view of the viewing participant 520 rotates clockwise within the virtual environment. As a result, lines 523 and 524 represent the movement of the leading edge of the view volume associated with the viewing participant 520. As such, line 523 represents the leading edge of the view volume at time t-2. At time t-2, the local participant 510 is not within the view volume of the viewing participant 520. Also, line 524 represents the leading edge of the view volume at time t-3. At time t-3, the local participant 510 is located within the view volume of the viewing participant 520.

In one embodiment, one method is disclosed for culling unnecessary streaming for objects that are not visible to the viewing participant 520. For example, in FIG. 5, the view volume that is defined by the leading edge 523 at time t-2 does not include the local participant 510 within the view volume. However, the extended bounding volume (EBV) 530 is included within the view volume as defined by the leading edge 523. As a result, video image streams of the local participant 510 are generated and sent to the viewing participant 520 before the local participant is visible within the virtual environment 500. This provides for visibility anticipation and hysteresis.

Hysteresis is provided by the EBV 530 in FIG. 5 by maintaining visibility for the local participant 510 which may have been visible but are just now not visible. Should the local participant 510 move back into sight and be visible to the viewing participant 520, the media stream will not have been stopped and the viewing participant 520 will perceive the correct view without any latency.

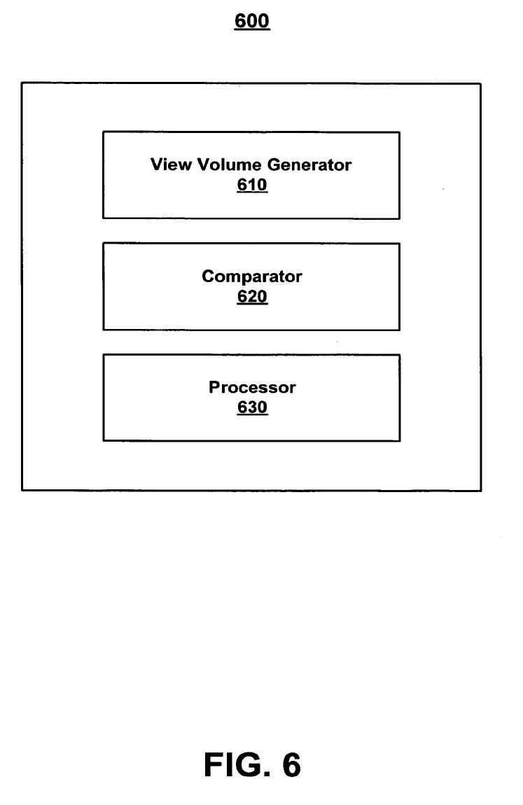

FIG. 6 illustrates a system 600 that is capable of culling video image streams when an object is not visible to the viewing participant within a virtual environment. The system 800 comprises a view volume generator 610. The view volume generator 610 determining a view volume of a viewing participant within the virtual environment. The view volume defines a field-of-view of the viewing participant within the virtual environment. The system 600 further comprises a comparator 620 communicatively coupled to the view volume generator 610. The comparator 620 determines a proximity of a representation of an observed object in the virtual environment to the view volume. The system 600 further comprises a processor communicatively coupled to the comparator 620 for processing a view dependent visual data stream of the observed object only when the representation is within a specified proximity to the view volume.

The preferred embodiments of the present invention, a method and system for culling visual data streams within a virtual environment, is thus described. While the present invention has been described in particular embodiments, it should be appreciated that the present invention should not be construed as limited by such embodiments, but rather construed according to the below claims.

1. A method for culling view dependent visual data streams for a virtual environment, comprising:
determining a view volume of a viewing participant within said virtual environment, wherein said view volume defines a field-of-view of said viewing participant within said virtual environment;
determining a proximity of a representation of an observed object in said virtual environment to said view volume; and
processing a view dependent visual data stream of said observed object only when said representation is within a specified proximity to said view volume.

2. The method of claim 1, wherein said providing access to a source of said visual data further comprises:
computing a three-dimensional model of said observed object, said three-dimensional model based on a plurality of real-time video streams taken of said observed object from a plurality of sample viewpoints.

3. The method of claim 2, wherein said generating visual data streams further comprises:
generating a view dependent video image stream by applying a new view synthesis technique to said three-dimensional model of said observed object, wherein said video image stream is generated from a viewpoint of said viewing participant.

4. The method of claim 1, further comprising:
sending said visual data stream to said viewing participant.

5. The method of claim 1, wherein said determining a view volume further comprises:
determining a view direction of said viewing participant to define said view volume, wherein said view volume comprises a series of expanding cross-sections of a geometric object along said view direction from said viewing participant within said virtual environment.

6. The method of claim 5, wherein said geometric object comprises a four-sided rectangular plane.

7. The method of claim 1, wherein said determining a proximity of a representation of an observed object in said virtual environment to said view volume, further comprises:
determining that said representation is within said specified proximity;
determining when said representation is occluded in said view volume such that said observed is not visible to said viewing participant; and
not generating said video image stream when said representation is occluded.

8. The method of claim 1, further comprising:
providing for hysteresis and anticipation in delivering said video image stream to said viewing participant by defining an extended bounding volume that surrounds said observed object within said three-dimensional virtual environment, wherein said representation comprises said extended bounding volume when determining said proximity.

9. The method of claim 1, further comprising:
enabling a change in a location of said viewing participant within said three-dimensional virtual environment by determining a new view volume of said viewing participant within said virtual environment;
determining when said representation falls within said new view volume; and
generating a video image stream of said observed object from said three-dimensional model when said representation is within said specified proximity to said new view volume

10. The method of claim 1, further comprising:
enabling a change in location of said observed object within said three-dimensional virtual environment and reflecting said change in location in said representation.

11. The method of claim 1, wherein said observed object comprises a local participant.

12. The method of claim 1, wherein said virtual environment comprises a three dimensional N-way virtual collaborative environment.

13. A system for culling view dependent visual data for a virtual environment, comprising:
a view volume generator for determining a view volume of a viewing participant within said virtual environment, wherein said view volume defines a field-of-view of said viewing participant within said virtual environment;
a comparator for determining a proximity of a representation of an observed object in said virtual environment to said view volume; and
a processor for processing a view dependent visual data stream of said observed object only when said representation is within a specified proximity to said view volume.

14. The system of claim 13, wherein said source comprises:
a model generator computing a three-dimensional model of said observed object that is based on a plurality of real-time video streams taken of said observed object from a plurality of sample viewpoints; and
a new view synthesis module for generating a view dependent video image stream by applying a new view synthesis technique to said three-dimensional model of said observed object, wherein said video image stream is generated from a viewpoint of said viewing participant.

15. The system of claim 13, further comprising:
a transmitter for sending said visual data stream to said viewing participant.

16. The system of claim 13, wherein said view volume generator determines a view direction of said viewing participant to define said view volume, wherein said view volume comprises a series of expanding cross-sections of a geometric object along said view direction from said viewing participant within said virtual environment

17. The system of claim 13, wherein said comparator determines when said representation is occluded in said view volume such that said viewing participant is unable to view said observed object, such that said video image stream is not generated when said representation is occluded.

18. The system of claim 13, wherein said representation comprises an extended bounding volume that surrounds said observed object within said virtual environment, wherein said representation comprises said extended bounding volume when determining said proximity.

19. The system of claim 13, wherein said view volume generator enables a change in a location of said viewing participant to a new location within said virtual environment by changing said view volume of said viewing participant within said virtual environment to reflect said new location.

20. The system of claim 13, wherein said comparator enables a change in location of said observed object to a new location within said three-dimensional virtual environment and reflects said change in location in said representation.

21. A computer system comprising:
a processor; and
a computer readable memory coupled to said processor and containing program instructions that, when executed, implement a method for culling view dependent visual data streams for a virtual environment, comprising:
determining a view volume of a viewing participant within said virtual environment, wherein said view volume defines a field-of-view of said viewing participant within said virtual environment;
determining a proximity of a representation of an observed object in said virtual environment to said view volume; and
processing a view dependent visual data stream of said observed object only when said representation is within a specified proximity to said view volume.

22. The computer system of claim 21, wherein said providing access to a source of said visual data in said method further comprises:
computing a three-dimensional model of said observed object, said three-dimensional model based on a plurality of real-time video streams taken of said observed object from a plurality of sample viewpoints.

23. The computer system of claim 22, wherein said generating visual data streams in said method further comprises:
generating a view dependent video image stream by applying a new view synthesis technique to said three-dimensional model of said observed object, wherein said video image stream is generated from a viewpoint of said viewing participant.

24. The computer system of claim 21, wherein said method further comprises:
sending said visual data stream to said viewing participant.

25. The computer system of claim 21, wherein said determining a view volume in said method further comprises:
determining a view direction of said viewing participant to define said view volume, wherein said view volume comprises a series of expanding cross-sections of a geometric object along said view direction from said viewing participant within said virtual environment.

26. The computer system of claim 25, wherein said geometric object comprises a four-sided rectangular plane.

27. The computer system of claim 21, wherein said determining a proximity of a representation of an observed object in said virtual environment to said view volume in said method, further comprises:
determining that said representation is within said specified proximity;
determining when said representation is occluded in said view volume such that said observed is not visible to said viewing participant; and
not generating said video image stream when said representation is occluded.

28. The computer system of claim 21, wherein said method further comprises:
providing for hysteresis and anticipation in delivering said video image stream to said viewing participant by defining an extended bounding volume that surrounds said observed object within said three-dimensional virtual environment, wherein said representation comprises said extended bounding volume when determining said proximity.

29. The computer system of claim 21, wherein said method further comprises:
enabling a change in a location of said viewing participant within said three-dimensional virtual environment by determining a new view volume of said viewing participant within said virtual environment;
determining when said representation falls within said new view volume; and
generating a video image stream of said observed object from said three-dimensional model when said representation is within said specified proximity to said new view volume

30. The computer system of claim 21, wherein said method further comprises:
enabling a change in location of said observed object within said three-dimensional virtual environment and reflecting said change in location in said representation.

31. The computer system of claim 21, wherein said observed object comprises a local participant.

32. The computer system of claim 21, wherein said virtual environment comprises a three dimensional N-way virtual collaborative environment.

33. A computer readable medium containing executable instructions which, when executed in a processing system, causes the system to perform the steps for a method of culling view dependent visual data streams for a virtual environment, comprising:
determining a view volume of a viewing participant within said virtual environment, wherein said view volume defines a field-of-view of said viewing participant within said virtual environment;
determining a proximity of a representation of an observed object in said virtual environment to said view volume; and
processing a view dependent visual data stream of said observed object only when said representation is within a specified proximity to said view volume.
